(19) United States
(12) Patent Application Publication
(10) Pub. No.: US 2019/0325045 A1
(43) Pub. Date: Oct. 24, 2019

(54) SCHEMA DATA STRUCTURE

(71) Applicant: Hewlett-Packard Development Company, L.P., Houston, TX (US)

(72) Inventors: Kevin WILLIAMS, San Diego, CA (US); Amit Kumar SINGH, Houston, TX (US); Gaurav ROY, Houston, TX (US)

(21) Appl. No.: 15/958,490

(22) Filed: Apr. 20, 2018

(51) Int. Cl. G06F 17/30

(52) U.S. Cl. CPC G06F 17/30292; G06F 17/30005; G06F 17/30315; G06F 17/30339

(57) ABSTRACT

A system is provided including a memory in communication with a processor. The memory is to store a schema data structure. The processor is to store in association with one another in the schema data structure: a table identifier for a data table, a column identifier for a column of the data table, and a column position for the column. The processor is also to generate a data type based on data type information associated with the column. In addition, the processor is to store the data type in the schema data structure in association with the table identifier, the column identifier, and the column position, and to output the schema data structure.

### BACKGROUND

Data may be collected and organized in data structures stored in computer-readable memory. These data structures may store large volumes of data collected over time. Computers may be used to retrieve and process the data stored in the data structures.

### BRIEF DESCRIPTION OF THE DRAWINGS

FIG. 1 shows a flowchart of an example method that may be used to generate a schema table.

FIG. 2 shows example data tables.

FIG. 3 shows further example data tables.

FIG. 4 shows a schematic representation of an example Device-as-a-Service ecosystem.

FIG. 5 shows a block diagram of an example computing system.

FIG. 6 shows a block diagram of an example computer-readable storage medium.

### DETAILED DESCRIPTION

Increasing volumes of data are being generated, collected, and processed. Some examples of sources of such data include connected sensors, connected objects or things within an Internet-of-Things scheme, and connected devices within a Device-as-a-Service (DaaS) ecosystem. In a DaaS ecosystem a DaaS provider provides the use of devices, such as computing devices, to customers. The DaaS provider may retain responsibility for the devices, for example to update and/or maintain the devices.

The DaaS provider may collect data from the devices and/or customers within the DaaS ecosystem to assist with maintaining the devices and their performance. As the number of devices and customers increase, and the data collection times lengthen, the volume of data stored in the data sources may increase. Such data about the devices and customers may be collected and stored in one or multiple data structures.

These data structures may be replicated, for example to create backups or to provide additional copies of the data for analysis and manipulation. In addition, as some data structures are used over extended time periods, the structure or the definition of the data structures may change over time through intentional updates or unintended changes.

The structure or definition of a data structure may be referred to as a schema for that data structure. For example, when the data structure is a data table, the schema may comprise the name of the table, the names and the relative positions of the columns, and the data type for the data to be stored in the columns.

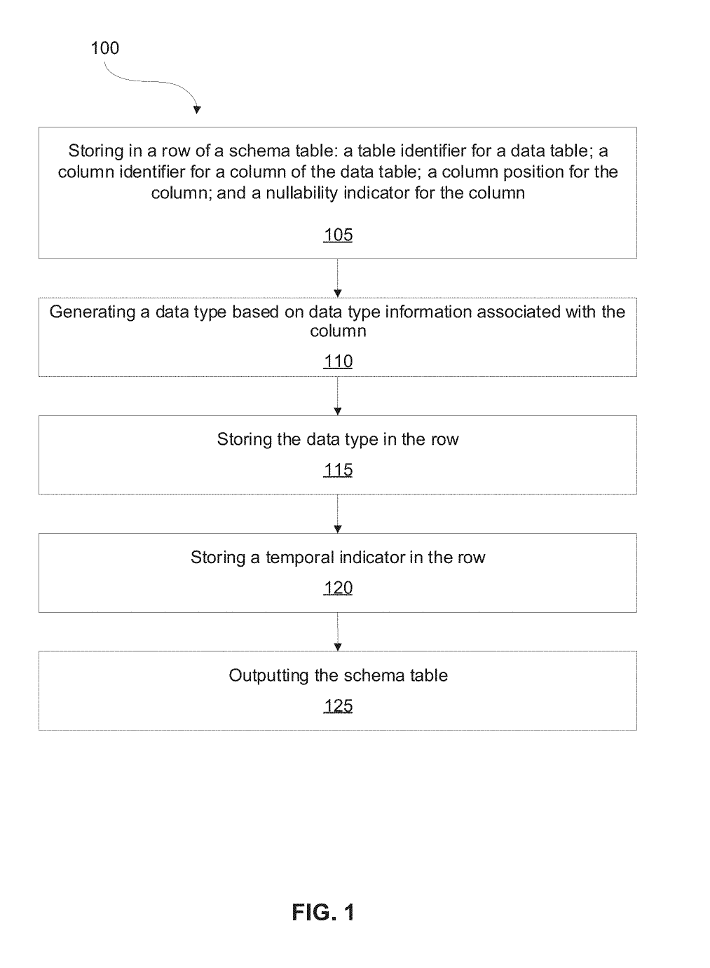

FIG. 1 shows a flowchart of an example method 100 that may be used to generate a schema data structure, such as a schema table, for a data table. The schema table, in turn, may allow for replication of and for tracking changes to the schema of the data table. At box 105 of method 100, the following may be stored in a row of a schema table: a table identifier for a data table, a column identifier for a column of the data table, a column position for the column, and a nullability indicator for the column.

In some examples, the data table may comprise a table storing information about the devices that are provided to customers as part of a DaaS ecosystem. For example, such a table may have as its identifier a table name “device”. The device data table may have columns having as column identifiers column names such as “serialno”, “mfg”, “disk_space” and the like, respectively indicating that the columns are to store serial numbers, manufacturer information, and the available disk space of devices.

Column position may comprise the ordinal position of a column in the table. In other words, column position may comprise an indicator of the position of a column in relation to the data table and/or in relation to other columns in the data table. In some examples, the column position may comprise a natural number indicating the position of the column from the left edge of the data table, such that the first column from the left is assigned column position “1”, the second column from the left is assigned column position “2”, and so on.

The nullability indicator may comprise an indication of whether the column may have null or missing values. In some examples, the nullability indicator may comprise “YES”/“NO”, a Boolean indicator, and the like. For example, in a DaaS ecosystem the device data table may be defined or structured such that the serial number column cannot have null values, in which case the nullability indicator may be “NO” for the serial number column in the schema table.

At box 110, a data type may be generated based on data type information associated with the column. The data type may indicate the type and/or format of the data storable in the corresponding column. In some examples, the data type information may comprise an initial data type and/or a data type descriptor related to the column.

Furthermore, in some examples, generating the data type may comprise converting or mapping the initial data type to the data type to be stored in the schema table. The data type may be selected such that the data type is able to store or accommodate the data values stored as having the initial data type. Moreover, in some examples, generating the data type may comprise combining the data type descriptor with the initial data type to obtain the data type.

At box 115, the data type may be stored in the row. Storing the data type in the row may associate the data type with the table identifier, the column identifier, the column position, and the nullability indicator. Moreover, at box 120 a temporal indicator may also be stored in the row, in association with the table identifier, the column identifier, the column position, the nullability indicator, and the data type.

The temporal indicator may comprise an indication of a currency of information stored in the row of the schema table. For example, the temporal indicator may indicate the date and/or time when the table identifier, the column identifier, the column position, the nullability indicator, and/or the data type are collected, last updated, or current as of. In some examples, the temporal indicator may comprise the date and/or time when the data type was generated and/or stored in the row of the schema table.

Moreover, at box 125 the schema table may be output To output the schema table, the schema table may be stored in a memory, sent to an output terminal, communicated to another component or to another system, or the like. In some examples, before completing box 125, boxes 105, 110, 115, and 120 may be repeated to add additional rows to the schema table, where the additional rows have corresponding table identifiers, column identifiers, column positions, nullability indicators, data types, and temporal indicators. The additional rows of the schema table may correspond to additional columns of the data table.

In some examples, the schema table may store information about more than one data table. In addition, in some examples the schema table may store information about the same data table at more than one time. In such examples, boxes 105, 110, 115, and 120 may be repeated at different times, on demand or according to a schedule. The temporal indicator may be updated to reflect the currency of the information being stored in the schema table during a new or additional iteration of boxes 105, 110, 115, and 120.

In some examples, the table identifier, the column identifier, the column position, the nullability indicator, the data type, and the temporal indicator may be stored and associated with one another in a data structure other than a table. An example of such other data structure may comprise a schema file such as a text file. In such examples, method 100 may output this other schema data structure instead of the schema table.

Furthermore, in some examples, the schema data structure may store the structure or definition of a data structure other than a data table. For example, the schema data structure may relate to a data file, in which case the schema data structure may store attributes of the data file such as file name, data type for the data storable in the file, the maximum storage capacity of the file, and the like.

In addition, in some examples, the data type information may comprise an initial data type and generating the data type may comprise converting the initial data type to the data type. In some examples, converting the initial data type to the data type may comprise mapping the initial data type to the data type stored in the schema table. Moreover, in some examples the initial data type may comprise a bespoke or data storage platform specific initial data type, and the data type may comprise a data type recognizable across multiple platforms or a data type that is generally-recognizable across many platforms.

For example, the data table may indicate a bespoke or data storage platform specific initial data type for the serial number column, such as using “bigfloat” to indicate that the serial number column may store real number data values. In this example, generating the data type for inclusion in the schema table may comprise converting or mapping “bigfloat” to “float”, where “float” may be a data type recognizable across multiple platforms. Converting platform-specific data types to more generally-recognizable data types may allow the schema table to be portable across and usable in multiple data storage platforms.

Moreover, in some examples the data type information may comprise an initial data type and a data type descriptor associated with the initial data type. In some examples, the data type descriptor may comprise subtype or format information for the initial data type. Generating the data type, in turn, may comprise combining the initial data type and the data type descriptor to obtain the data type.

For example, the initial data type may comprise “float” and the data type descriptor may comprise two numbers, ‘X’ and ‘Y’, respectively specifying the maximum number of digits to the left and to the right of the decimal point of the float number. Combing the initial data type and the data type descriptor may yield a data type having the format “float(X,Y)”, which may then be stored in the schema table.

In further examples, the data type descriptor may comprise a maximum length or number of characters associated with the initial data type. In such an example, the data type may be generated by forming the combination “initial_type(max_length)”. In other examples, the initial data type and the data type descriptor may be combined in a format different than “initial_type(data_type_descriptor)”.

Combining the initial data type and the data type descriptor into one data type may allow the data type to be storable in a cell of the schema table. In other words, the data type may be able to be stored in the row under one column of the schema table, with the intersection of the row and the column of the schema table representing a cell of the schema table.

By combining potentially separate data items of the initial data type and the data type descriptor into a single data item of the data type storable in a cell of the schema table, the size of the table and the amount of storage used for storing the schema may be reduced.

In addition, converting platform-specific data types into more generally-recognizable data types may allow the schema data structures formed according to the methods described herein to be more portable between different data storage platforms. Such schema data structures may be used to replicate their corresponding data tables across multiple different data storage platforms.

Moreover, in examples where the schema information for the data table is stored in the schema table at multiple times with correspondingly different temporal indicators, the schema tables described herein may be used to track changes to the scheme of the data table over time. If a change is unintended or problematic, the schema table may allow for potentially restoring the data table to a schema stored in the schema table prior to the change.

For greater clarity, replicating or tracking changes to a data structure using a schema data structure refer to replicating or tacking changes to the structure or definition of the data structure, and not to replicating or tracking changes to the data values stored within the data structure.

As such, the methods and schema data structures described herein may allow for the schema for a data table or other data structure used to store information related to a DaaS ecosystem to be replicated across multiple platforms and for changes to the schema to be tracked over time and potentially rolled back.

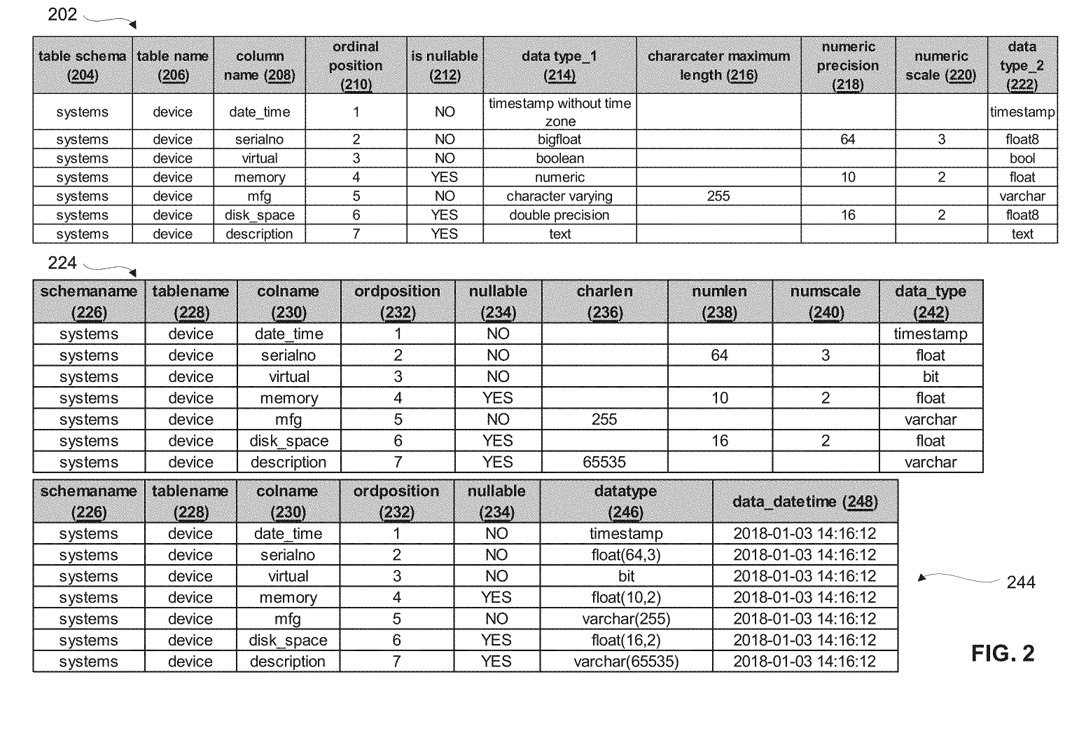

FIG. 2 shows example data tables. Some aspects of the example methods disclosed herein will be described with reference to the example tables shown in FIG. 2. The reference to the tables of FIG. 2 is for demonstrative purposes, and the methods disclosed herein are not limited to or by the example data values or data structures shown in FIG. 2.

Table 202, shown in FIG. 2, is an example schema data source. Table 202 may be provided by a database or a data storage platform, or may be provided in a different manner. Table 202 comprises the following columns: table schema 204, table name 206, column name 208, ordinal position 210, “is nullable” 212, data type_1 214, character maximum length 216, numeric precision 218, numeric scale 220, and data type_2 222.

Column table schema 204 may store an identifier or name for a schema, such as the schema name “systems” as shown in table 202. Column table name 206 may store the name of the data table whose schema information is being provided in table 202. In this case, the table name is “device”.

Moreover, column column name 208 may provide the names of the various columns of the “device” data table. Column ordinal position 210, in turn, may provide the ordinal position of the columns in the “device” data table. In addition, column “is nullable” 212 may indicate whether the columns of the “device” data table may have null or missing data values.

Furthermore, columns data type_1 214 and data type_2 222 may provide different ways to describe the data types of the columns of the “device” data table. These data types may be bespoke or data storage platform specific to varying extents. For example, table 202 may indicate the data type for the second column of “device” data table as both “bigfloat” and “float8”. Both of these data type designations may be specific to the database or data storage platform that generated table 202. The other columns of the “device” data table may have corresponding data types in table 202.

The remaining three columns of table 202 may provide data type descriptors for the data types of the columns of the “device” data table. Column character maximum length 216 may provide the maximum length for a given data type. For example, table 202 indicates that the fifth column may store data of type “varchar” having a maximum character length of 255 characters.

Column numeric precision 218 may indicate the maximum number of characters to the left of the decimal point for a float data type, and column numeric scale 220 may indicate the maximum number of characters to the right of the decimal point for the float data type. For example, table 202 indicates that for the fourth column of the “device” data table the data type may be a float type that has at most ten characters to the left of the decimal place and two characters to the right of the decimal place.

Turning next to table 244, a schema table is shown that is generated from the information provided in table 202. The five left most columns of table 244 contain the same content or data values as the corresponding five left most columns of table 202. These five columns are as follows: schemaname 226, tablename 228, colname 230, ordposition 232, and nullable 234. While FIG. 2 shows these five columns as having columns names different than the names of the corresponding five left most columns of table 202, it is contemplated that in some examples the five left most columns of tables 202 and 244 may have the same column names.

Table 244 also comprises column datatype 246, which stores data types corresponding to the columns of the “device” data table. The data types in column datatype 246 may be generated using the data type information in table 202. Referring to the first column of the “device” data table, the “timestamp” data type is generated by reproducing the initial data type indicated in column data type_2 222 of table 202. Data type “time stamp without time zone” from column data type_1 214 of table 202 is not chosen when generating the data type stored in table 244 because “time stamp without time zone” is more specific to the platform that generated table 202 and a less generally recognizable by data storage platforms.

Referring to the second column of the “device” data table, the data type “float(64,3)” in table 244 is generated by converting the initial data types “bigfloat” and “float8” from table 202 to the more generally recognizable “float” data type, and by adding in brackets the data type descriptors comprising numeric precision and numeric scale.

Moreover, referring to the third column of the “device” data table, the “bit” data type is generated by converting or mapping “boolean” and “bool” initial data types in table 202 to “bit”. Referring next to the fifth column of the “device” data table, the “varchar(255)” data type is generated by selecting the more generally recognizable “varchar” from among “character varying” and “varchar” initial data types in table 202. In addition, the data type descriptor of “255” maximum character length from table 202 is added in brackets to “varchar” to generate the data type “varchar(255)”.

Furthermore, referring to the seventh column of “device” data table, the “varchar(65535)” data type is generated by converting or mapping the initial data type “text” from table 202 to the more generally recognizable “varchar”. In addition, in this example predetermined data type conversion rules may indicate that “text” is to be converted to “varchar(65535)”, where “65535” represents the maximum number of characters allowed by broadly-accepted definitions of the “varchar” data type.

More generally recognizable data types may be those that are recognizable by and accepted in a larger number of database platforms or other data storage platforms. As shown in FIG. 2, by using and storing more generally recognizable data types, schema table 244 may be portable across and usable in a larger number of database and other data storage platforms. In addition, by combining initial data type and data type descriptor information from up to three columns of table 202 into a single column datatype 246 of table 244, schema table 244 may reduce the table size and the corresponding amount of storage needed to store the schema information.

In addition, formatting data types as “data_type(data_type_descriptor)” may facilitate the use of simple commands to replicate the structure of a data table such as the “device” data table. These commands may be portable across and executable in multiple data storage platforms. For example, the combination of the following commands may be used to replicate the structure of the “device” data table:

SELECT ‘CREATE TABLE ’ || schemaname || ‘.’ || tablename || ‘ (’ ||
LISTAGG(colname || ‘ ’ || datatype || “ || CASE WHEN nullable = ‘NO’
THEN ‘NOT NULL’ ELSE ” END, ‘, ’) || ‘)’ FROM table_244 GROUP
BY schemaname, tablename;

(command A)

CREATE TABLE systems.device (date_time timestamp NOT NULL,
serialno float(64,3) NOT NULL, virtual bit NOT NULL, memory
float(10,2), mfg varchar(255) NOT NULL, disk_space float(16,2),
description varchar(65535));

(command B)

Commands A and B may be executable in data storage platforms that support Structured Query Language (SQL). As there is a large number of data storage platforms that support SQL and also the “table” data structure, schema table 244 and commands A and B may be portable across a correspondingly large number of data storage platforms, and may be used in those platforms for replicating the structure of the “device” data table.

Table 244 may also comprise column data_datetime 248 which stores date and time temporal indicators for the information on the rows of table 244. The temporal indicators may indicate the currency of the information stored in their corresponding rows. For example, the date and time information in column data_datetime 248 may indicate the time/date as of which the information in the corresponding row of table 244 is valid and/or current. In other examples, the date and time information in column data_datetime 248 may indicate one of the following: when the source schema information was obtained form table 202, when the information from table 202 was used to generate the data types stored in column datatype 246, or when schema information was stored in a corresponding row of table 244.

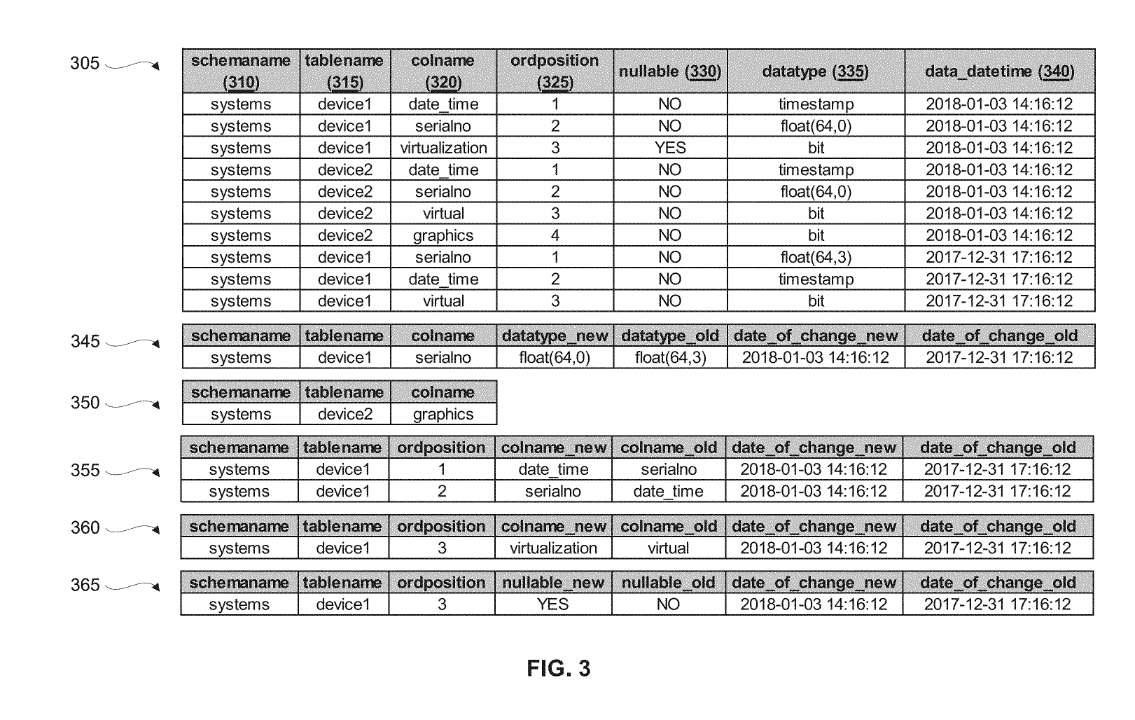

The temporal indicators stored in column data_datetime 248 may be used to store and track changes to the schema of the “device” data table over time. This, in turn, may allow for changes to the schema to be rolled back on an earlier state. FIG. 3, described below, shows examples of using a schema table 305 to determine and track changes to the schema of a data table.

Referring back to table 244, while FIG. 2 shows the source schema data being obtained from table 202, it is contemplated that the source schema data for table 244 may be obtained from a data structure or a data source different than table 202. In addition, while the schema information stored in table 244 is presented in a data table, it is contemplated that in other examples the schema information, including the generated data types and the temporal indicators, may be stored in a different data structure. Examples of such different data structures may comprise text files, where the schema information may be stored as comma-separated values (CSV).

In addition, FIG. 2 shows an intermediate table 224, which comprises five left-most columns being the same as the five left-most columns of table 244. Table 224 also comprises the following columns: charlen 236, numlen 238, numscale 240, and data_type 242. In some examples, table 224 may be generated using table 202, and then table 244 may be generated using table 224. In other examples, table 244 may be generated directly from table 202.

Column data_type 242 may store data types that are generated by converting or mapping the data types from table 202 into more generally recognizable data types. Moreover, in some examples table 224 may have column names that are modified relative to the column names of table 202.

Turning now to FIG. 3, a schema table 305 is shown, which may comprise the following columns: schemaname 310, tablename 315, colname 320, ordposition 325, nullable 330, datatype 335, and data_datetime 340. These columns may store similar information as the corresponding columns of table 244.

A difference between table 244 and table 305 is that table 305 stores schema information for data table “device1” on two different dates. In addition, table 305 stores schema information for a second data table “device2”. As such, table 305 may be used to track changes to the schema of data table “device1”, as well as compare the schema of data table “device1” with that of data table “device2”. Tables 345, 350, 355, 360, and 365 show the results of example queries of table 305 directed to tracking changes to “device1” and comparing “device1” and “device2”.

Table 345 shows the results of a query to determine if the data type for the columns of data table “device1” changed between the first date of Dec. 31, 2017 and the second date of Jan. 3, 2018. Table 345 indicates that the data type for column serialno of data table “device1” changed between these first and second dates.

Table 350 shows the results of a query to find added columns in table ‘device2’ using ‘device1’ as a comparison point. Table 350 indicates that table “device2” has an added column named graphics.

Moreover, table 355 shows the results of a query to find whether the order or position of the columns of table “device1” changed between the first and second dates. Table 355 indicates that columns date_time and serialno of table “device1” switched their positions between the first and second dates.

Furthermore, table 360 shows the results of a query to find whether columns of table “device1” changed their name between the first and second dates. Table 360 indicates that the third column of table “device1” changed its name from virtualization to virtual between the first and second dates.

In addition, table 365 shows the results of a query to find whether columns of table “device1” changed their nullability indicator between the first and second dates. Table 365 indicates that the third column of table “device1” changed its nullability indicator from YES to NO between the first and second dates.

If the changes detected and summarized in tables 345, 355, 360, and 365 are unintended or problematic, schema table 305 may allow those changes to be rolled back to the state at the first date prior to the change. Moreover, if the difference between the schema of tables “device1” and “device2” are unintended to problematic, schema table 305 may be used to detect the differences and also to change the schema of the two tables to rectify the problem.

Schema tables such as tables 244 and 305 may be used in the context of a DaaS ecosystem, to allow for storing and tracking over time in a memory-efficient manner the schema of the data structures used to store the customer, device, and other data related to the ecosystem. Such schema tables may also be portable across and accepted in multiple data storage platforms, which in turn may facilitate replicating or backing up the data structures of the DaaS ecosystem in different data storage platforms.

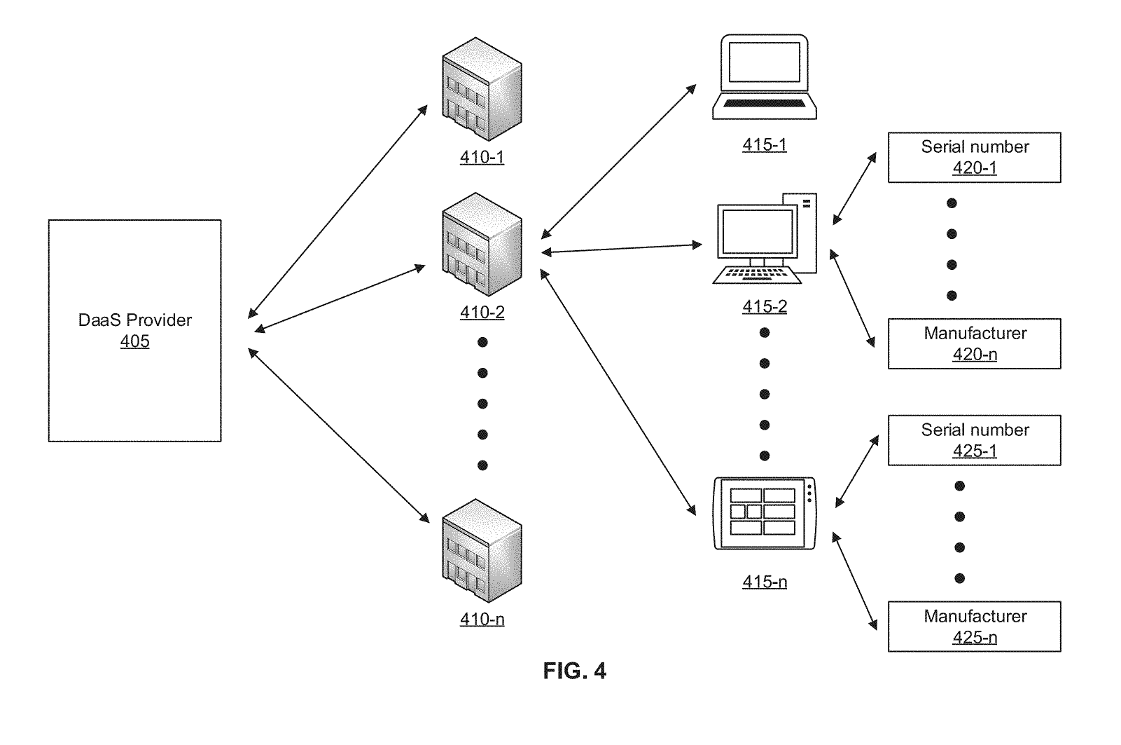

FIG. 4 shows a schematic representation of an example DaaS ecosystem comprising a DaaS provider 405, which serves customers 410-1, 410-2 to 410-n, collectively referred to as customers 410.

The DaaS provider 405 may provide to a customer a number of devices 415-1, 415-2 to 415-n, collectively referred to as devices 415. While devices are shown in FIG. 4 only for customer 410-2, the other customers may also be provided with devices. Moreover, while devices 415 are shown as being connected to DaaS provider 405 through customer 410-2, it is contemplated that devices 415 may be in direct communication with DaaS provider 405.

A device may have a number of associated data values, which may be static or dynamic over time. For example, device 415-2 may have a number of associated data values including a serial number 420-1, a manufacturer 420-n, and the like. Similarly, device 415-n may have a number of associated data values including a serial number 425-1, a manufacturer 425-n, and the like. While not shown in FIG. 4, other devices such as device 415-1 may also have associated data values.

DaaS provider 405 may collect time-series data on device data values to monitor the performance of and diagnose problems relating to devices 415. Moreover, DaaS provider 405 may also collect and monitor data relating to customers 410 such as the customers' company name and the like. The methods described herein may provide portable and memory-efficient schema data structures such as schema tables for storing the schema of the data structures used to store the device, customer, and other information related to the DaaS ecosystem. In addition, the schema data structures described herein may allow for tracking over time changes to the schema of the data structures of the DaaS ecosystem, and to restoring an earlier schema if the later changes are unintended or problematic.

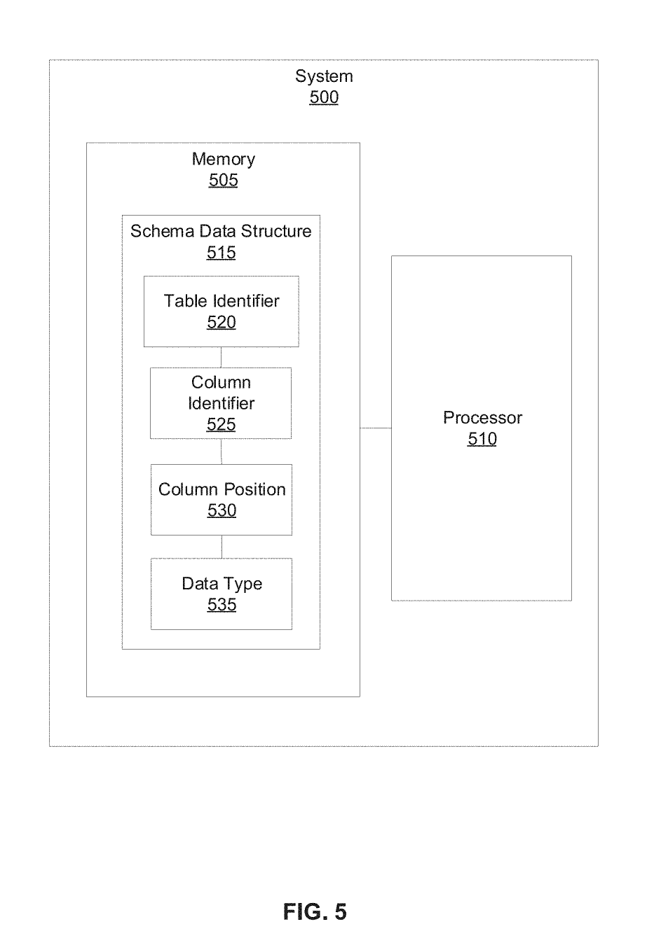

Turning now to FIG. 5, a system 500 is shown which may be used to generate a schema data structure such as a schema table. System 500 comprises a memory 505 in communication with a processor 510. Processor 510 may include a central processing unit (CPU), a graphics processing unit (GPU), a microcontroller, a microprocessor, a processing core, a field-programmable gate array (FPGA), or similar device capable of executing instructions. Processor 510 may cooperate with the memory 505 to execute instructions.

Memory 505 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions. In some example systems, memory 505 may include a database.

Memory 505 may store a schema data structure 515. Processor 510, in turn, may store in association with one another in schema data structure 515 the following: a table identifier 520 for a data table, a column identifier 525 for a column of the data table, and a column position 530 for the column.

In addition, processor 510 may generate a data type 535 based on data type information associated with the column. Moreover, processor 510 may store data type 535 in schema data structure 515 in association with table identifier 520, column identifier 525, and column position 530.

Generating schema data structure 515 may be similar to generating the schema tables and data structures described herein in relation to FIGS. 1-3 and the methods described herein. In addition, while FIG. 5 shows schema data structure 515 stored in memory 505, it is contemplated that in other examples schema data structure 515 may be stored in system 500 outside of memory 505, or outside of system 500.

Moreover, in some examples, the schema data structure may comprise a schema table having a row, and table identifier 520, column identifier 525, column position 530, and data type 535 may be stored in association with one another by storing them in the row of the schema table. Moreover, in some examples the schema data structure may comprise a text file, or a page or portion of a text file, within which table identifier 520, column identifier 525, column position 530, and data type 535 may be stored to associate them with one another.

Furthermore, processor 510 may output schema data structure 515, for example by storing data structure 515 in memory 505 or another storage inside and/or outside of system 500, by sending data structure 515 to an output terminal, by sending data structure 515 to another system, and the like.

In some examples, processor 510 may further store a nullability indicator (not shown) in schema data structure 515 in association with table identifier 520, column identifier 525, and column position 530. Moreover, in some examples, processor 510 may further store a temporal indicator (not shown) in schema data structure 515 in association with table identifier 520, column identifier 525, and column position 530. The temporal indicator may comprise an indication of the currency of the information stored in schema data structure 515. The nullability indicator and the temporal indicator may be similar to those described herein in relation to FIGS. 1-3 and the methods described herein.

In addition, in some examples the data type information may comprise an initial data type, and to generate data type 535 processor 510 may convert the initial data type to data type 535. Furthermore, in some examples the data type information may comprise the initial data type and a data type descriptor associated with the initial data type. In these examples, processor 510 may combine the initial data type and the data type descriptor to generate data type 535. In examples where the schema data structure comprises a schema table, this data type 535 may be storable in a cell of the schema table. The generation and storage of data type 535 may be similar to those described herein in relation to FIGS. 1-3 and the methods described herein.

The example systems described herein may perform method 100 and the other methods and functions described herein, for example in relation to FIGS. 1-3. The example systems may also be used in the context of a DaaS ecosystem, for example as shown in FIG. 4.

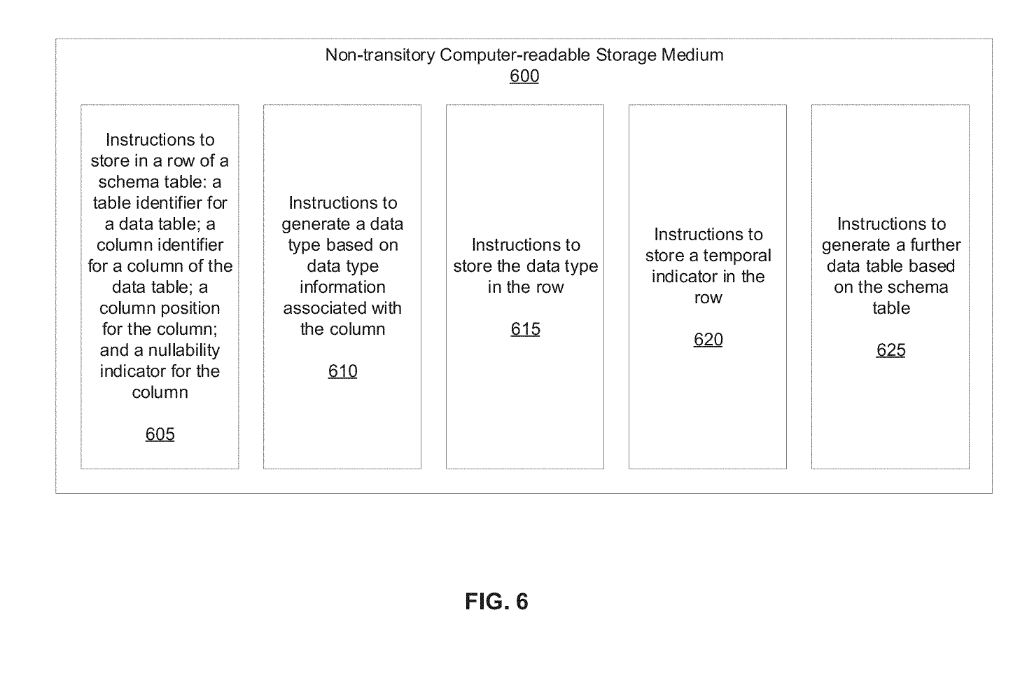

Turning now to FIG. 6, a non-transitory computer-readable storage medium (CRSM) 600 is shown, which comprises instructions executable by a processor. The CRSM may comprise an electronic, magnetic, optical, or other physical storage device that stores executable instructions. The instructions may comprise instructions 605 to cause the processor to store in a row of a schema table: a table identifier for a data table, a column identifier for a column of the data table, a column position for the column, and a nullability indicator for the column.

Moreover, the instructions may comprise instructions 610 to cause the processor to generate a data type based on data type information associated with the column. The instructions may also comprise instructions 615 to cause the processor to store the data type in the row, and instructions 620 to cause the processor to store a temporal indicator in the row. Generating the schema table may be similar to generating the schema tables and schema data structures described herein in relation to FIGS. 1-5 and the methods and systems described herein.

In addition, CRSM 600 may comprise instructions 625 to cause the processor to generate a further data table based on the schema table. Generating the further data table may comprise determining the number, order/position, and name of the columns for the further data table and setting the data types for its columns. In some examples, generating the further data table may also comprise setting the nullability indicator for the columns of the further data table.

In addition, in some examples the further data table may comprise a further column having a further column identifier, a further column position, a further nullability indicator, and a further data type respectively the same as the column identifier, the column position, the nullability indicator, and the data type related to the data table. Moreover, in some examples generating the further data table may comprise executing commands similar to commands A and B described above.

In examples where the schema data stored in the schema table is related to a data structure different than a data table, CRSM 600 may comprise instructions to cause the processor to generate a further data structure based on the schema table. Furthermore, it is contemplated that in some examples the schema information may be stored in a schema data structure other than a schema table. In these examples, the CRSM may comprise instructions to cause the processor to generate a further data table or other data structure based on the schema data structure. Moreover, in some examples, the instructions may cause the processor to generate multiple additional data structures based on the schema data structure.

Furthermore, in some examples the data type information may comprise an initial data type, and the instructions may be to cause the processor to convert the initial data type to the data type in order to generate the data type. Moreover, in some examples the data type information may comprise an initial data type and a data type descriptor associated with the initial data type. In these examples the instructions may be to cause the processor to combine the initial data type and the data type descriptor to generate the data type. In some examples, the data type may be storable in a cell of the schema table. The generation and storage of the data type may be similar to the generation and storage of the data types described herein in relation to FIGS. 1-5 and the methods and systems described herein.

In addition, in some examples the temporal indicator may comprise an indication of the currency of the information stored in the row of the schema table. The temporal indicator may be similar to the temporal indicator described herein in relation to FIGS. 1-5 and the methods and systems described herein.

The example CRSMs described herein may also comprise instructions to cause a processor and/or system to perform the methods described herein, to perform the functions demonstrated in FIGS. 1-3, and to be used in the context of a DaaS ecosystem, for example as shown in FIG. 4.

In some examples, the methods, systems, and CRSMs described herein may be implemented using operations, data structures, and/or platforms that are compatible with and/or able to execute SQL queries or PostgreSQL queries.

Moreover, the methods, systems, and CRSMs described herein may include the features and/or perform the functions described herein in association with one or a combination of the other methods, systems, and CRSMs described herein.

The methods, systems, and CRSMs described herein may allow for generating schema data structures that may be used to store the schema of a data structure in a portable and memory-efficient manner. The schema data structures may be used to replicate or backup data tables or other data structures in multiple data storage platforms. In addition, the schema data structures may be used to track changes to the schema of the data structures over time, or to compare the schema of multiple data structures.

It should be recognized that features and aspects of the various examples provided above may be combined into further examples that also fall within the scope of the present disclosure.

1. A method comprising:
storing in a row of a schema table:
a table identifier for a data table;
a column identifier for a column of the data table;
a column position for the column; and
a nullability indicator for the column;
generating a data type based on data type information associated with the column;
storing the data type in the row;
storing a temporal indicator in the row; and
outputting the schema table.

2. The method of claim 1, wherein:
the data type information comprises an initial data type; and
the generating the data type comprises converting the initial data type to the data type.

3. The method of claim 1, wherein:
the data type information comprises an initial data type and a data type descriptor associated with the initial data type; and
the generating the data type comprises combining the initial data type and the data type descriptor to obtain the data type.

4. The method of claim 3, wherein the data type is storable in a cell of the schema table.

5. The method of claim 1, wherein the temporal indicator comprises an indication of a currency of information stored in the row.

6. A system comprising:
a memory to store a schema data structure;
a processor in communication with the memory, the processor to:
store in association with one another in the schema data structure:
a table identifier for a data table;
a column identifier for a column of the data table; and
a column position for the column;
generate a data type based on data type information associated with the column;
store the data type in the schema data structure in association with the table identifier, the column identifier, and the column position; and
output the schema data structure.

7. The system of claim 6, wherein the processor is further to store a nullability indicator in the schema data structure in association with the table identifier, the column identifier, and the column position.

8. The system of claim 6, wherein the processor is further to store a temporal indicator in the schema data structure in association with the table identifier, the column identifier, and the column position.

9. The system of claim 8, wherein the temporal indicator comprises an indication of a currency of information stored in the schema data structure.

10. The system of claim 6, wherein the schema data structure comprises a text file.

11. The system of claim 6, wherein:
the schema data structure comprises a schema table having a row; and
the processor is to store the table identifier, the column identifier, the column position, and the data type in the row.

12. The system of claim 6, wherein:
the data type information comprises an initial data type; and
the processor is to convert the initial data type to the data type to generate the data type.

13. The system of claim 6, wherein:
the data type information comprises an initial data type and a data type descriptor associated with the initial data type; and
the processor is to combine the initial data type and the data type descriptor to generate the data type.

14. The system of claim 13, wherein:
the schema data structure comprises a schema table; and
the data type is storable in a cell of the schema table.

15. A non-transitory computer-readable storage medium comprising instructions executable by a processor, the instructions to cause the processor to:
store in a row of a schema table:
a table identifier for a data table;
a column identifier for a column of the data table;
a column position for the column; and
a nullability indicator for the column;
generate a data type based on data type information associated with the column;
store the data type in the row;
store a temporal indicator in the row; and
generate a further data table based on the schema table.

16. The non-transitory computer-readable storage medium of claim 15, wherein:
the data type information comprises an initial data type; and
the instructions are to cause the processor to convert the initial data type to the data type to generate the data type.

17. The non-transitory computer-readable storage medium of claim 15, wherein:
the data type information comprises an initial data type and a data type descriptor associated with the initial data type; and
the instructions are to cause the processor to combine the initial data type and the data type descriptor to generate the data type.

18. The non-transitory computer-readable storage medium of claim 17, wherein the data type is storable in a cell of the schema table.

19. The non-transitory computer-readable storage medium of claim 15, wherein the temporal indicator comprises an indication of a currency of information stored in the row.

20. The non-transitory computer-readable storage medium of claim 15, wherein the further data table comprises a further column having a further column identifier, a further column position, a further nullability indicator, and a further data type respectively the same as the column identifier, the column position, the nullability indicator, and the data type.
